(19) United States
(12) Patent Application Publication
(10) Pub. No.: US 2010/0010823 A1
(43) Pub. Date: Jan. 14, 2010

(54) SYSTEMS AND METHODS FOR NETWORK BASED CUSTOMER SERVICE

(75) Inventors: German Scipioni, San Jose, CA (US); Andy Pease, San Francisco, CA (US); Kevin M. Busch, Omaha, NE (US); Liang Xi, Elkhorn, NE (US); Landon Cory Menear, Bellevue, NE (US)

Correspondence Address: Haynes and Boone, LLP;IP Section, 2323 Victory Avenue, SUITE 700, Dallas, TX, 75219, US

(73) Assignee: eBay Inc., San Jose, CA (US)

(21) Appl. No.: 12/172,424

(22) Filed: Jul. 14, 2008

(51) Int. Cl. G06Q 99/00

(52) U.S. Cl. 705/1

(57) ABSTRACT

In accordance with one or more embodiments of the present disclosure, systems and methods for facilitating customer service over a network include receiving a service request from a user via the network, verifying an account related to the user, determining a priority of the user, generating a service identifier, and providing the service identifier to the user via the network. In various implementations, users may be prioritized based on a perceived value of the user so as to provide express customer service and support to highly valued and/or top-rated users. Users may select a support link to obtain a service code which may be used to immediately connect the user to a customer service agent that may provide the user with resolution to problems encountered by the user.

### BACKGROUND

1. Technical Field

The present invention generally relates to transactions on a network and more particularly to network based customer service.

2. Related Art

In some online environments, a user navigates through selectable pages of service provider sites to view information resources including online accounts. Sometimes, users may encounter problems when navigating through service provider sites. Typically, when requesting assistance, users are placed in a queue based on a first-come-first-served priority, which may frustrate some users including highly valued users. As such, the service provider may benefit from efficiently assisting highly valued users when problems are encountered to improve their user experience. Hence, there is a need for improving the prioritization of users requesting customer service and support so as to retain these users.

### SUMMARY

Systems and methods disclosed herein, in accordance with one or more embodiments, prioritize users based on a perceived value of the user so as to provide express customer service and support to highly valued and/or top-rated users. For example, users may select a support link to obtain a service identifier (e.g., a fast track code) which may be used to immediately connect the user to a customer service agent or representative that may provide the user with resolution to problems encountered by the user.

In accordance with an embodiment of the present disclosure, a system for facilitating customer service over a network includes a first component adapted to communicate with a user via a client device over the network and a second component adapted to receive a service request from the user via the network. The second components is adapted to verify an account related to the user, determine a priority for the user, generate a service identifier, and provide the service identifier to the user via the network.

In various implementations, the service request includes information related to a problem encountered by the user, and the service request includes at least one of an email address, an account identification number, and a uniform resource locator (URL) related to the user. The second component is adapted to verify the account related to the user based on information passed with the service request. The second component is adapted to determine the priority of the user by prioritizing the user based on a perceived value of the user. The second component is adapted to generate the service identifier based on the determined priority of the user. The second component is adapted to generate the service identifier by generating a unique service code including a randomly generated alpha-numeric code having one or more digits. The second component is adapted to access the account related to the user. The second component is adapted to store and/or display at least one of the service request, the priority of the user, and the service identifier. The system comprises a server adapted to facilitate customer service over the network.

In accordance with an embodiment of the present disclosure, a method for facilitating customer service over a network includes receiving a service request from a user via the network, verifying an account related to the user, and determining a priority of the user. The method includes generating a service identifier and providing the service identifier to the user via the network. In various implementations, verifying the account related to the user may be based on information passed with the service request, determining the priority of the user may include prioritizing the user based on a perceived value of the user, generating the service identifier may be based on the determined priority of the user, and generating the service identifier may include generating a unique service code including a randomly generated alpha-numeric code having one or more digits.

These and other features and advantages of the present disclosure will be more readily apparent from the detailed description of the embodiments set forth below taken in conjunction with the accompanying drawings.

### BRIEF DESCRIPTION OF THE FIGURES

FIG. 1 shows a block diagram of a system configured to facilitate customer service over a network, in accordance with an embodiment of the present disclosure.

FIG. 2 shows a method for facilitating customer service over a network, in accordance with an embodiment of the present disclosure.

FIG. 3 shows another method for facilitating customer service over a network, in accordance with an embodiment of the present disclosure.

FIG. 4A shows a client interface that may be viewed by a user, in accordance with an embodiment of the present disclosure.

FIG. 4B shows a customer service information window that may be viewed by a user, in accordance with an embodiment of the present disclosure.

FIG. 5 shows another method for facilitating customer service over a network, in accordance with an embodiment of the present disclosure.

FIG. 6 shows an agent interface that may be viewed by an agent, in accordance with an embodiment of the present disclosure.

FIG. 7 is a block diagram of a computer system suitable for implementing one or more embodiments of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

One or more embodiments of the present disclosure enable a network user to access a customer service agent via a service mechanism by selecting an image (e.g., link) displayed in a graphical user interface (GUI), such as a web browser. In various implementations, when enabled, the service mechanism allows the user to communicate with the customer service agent within a predetermined period of time. For example, the service mechanism provides an express telephone support number for the user to call the customer service agent for express assistance, which may be referred to as fast track customer service. In various embodiments, the service mechanism may be implemented within a browser application, bundled with an existing toolbar or application, and/or provided in a frames-based implementation that may not require the user to download an application.

To improve customer service, top-rated users that may be frustrated while accessing online services may chose to select a support link to receive a service identifier (e.g., a fast track code) which, when provided to a customer service provider, immediately connects the user to a customer service agent or representative that has information about where the user may be experiencing problems. Based on information passed with a service request, the customer service agent may be able to provide resolution to the user so as to improve the user's experience and perception of the service provider.

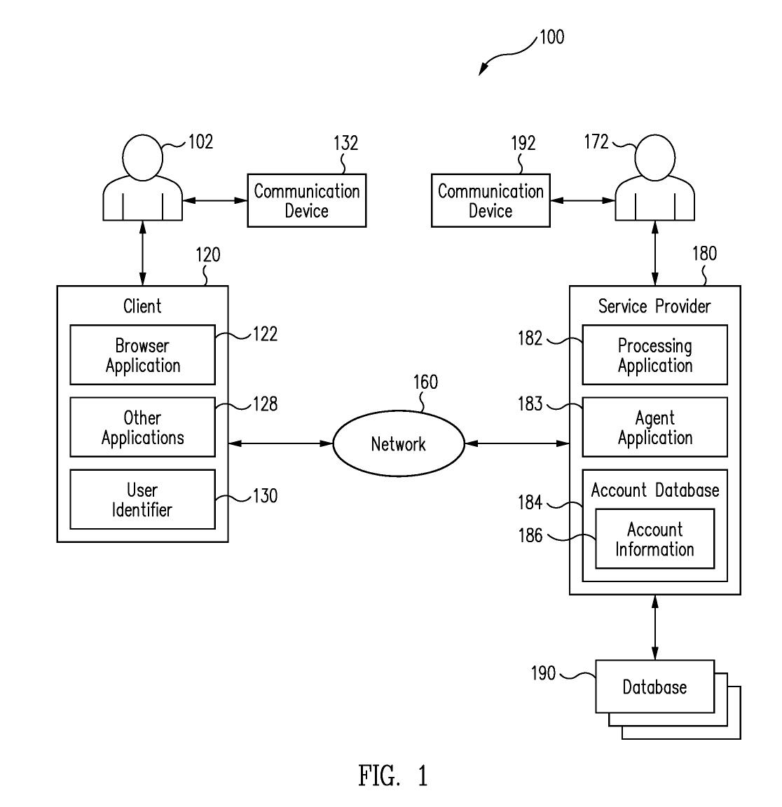

FIG. 1 shows one embodiment of a block diagram of a system 100 adapted to facilitate customer service over a network 160. As shown in FIG. 1, the system 100 includes at least one client device 120 and at least one service provider server 180 in communication over the network 160.

The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet.

The client device 120, in various embodiments, may be implemented using any appropriate combination of hardware and/or software configured for wired and/or wireless communication over the network 160. For example, the client device 120 may be implemented as a personal computer of a user 102 (e.g., a client or a customer) in communication with the network 160, such as the Internet. In other examples, the client device 120 may be implemented as a wireless telephone (e.g., cell phone), personal digital assistant (PDA), notebook computer, and/or various other generally known types of wired and/or wireless computing devices. It should be appreciated that, in various embodiments, the client device 120 may be referred to as a user device or a customer device without departing from the scope of the present disclosure.

The client device 120, in various embodiments, may include one or more browser applications 122 that may provide the user 102 with a user interface to browse information available over the network 160. For example, the browser application 122 may be implemented as a web browser to view information available over the network 160, such as the Internet. In one implementation, the browser application 122 comprises a software program, such as a graphical user interface (GUI), executable by a processor that is adapted to interface and communicate with the service provider server 180 via the network 160. For example, the user 102 is able to access a service provider website via the service provider server 180 to view information related to the user 102. The service provider server 180 may comprise a network server maintained by a service provider that provides a payment service and/or an account management service, which is described in greater detail herein.

The client device 120, in one embodiment, may include other applications 128 as may be desired in one or more implementations to provide additional features available to the user 102. In one example, such other applications 128 may include security applications for implementing client-side security features, programmatic client applications for interfacing with appropriate application programming interfaces (APIs) over the network 160 or various other types of generally known programs and/or applications.

The client device 120, in one embodiment, may include one or more user identifiers 130, which may be implemented as operating system registry entries, cookies associated with the browser application 122, identifiers associated with hardware of the client device 120, and/or various other appropriate identifiers. The user identifier 130 may include attributes related to the user102, such as personal information (e.g., a user name, password, photograph image, biometric id, address, social security number, phone number, email address, etc.) and banking information (e.g., banking institution, credit card issuer, user account numbers, security information, etc.). In various implementations, the user identifier 130 may be passed with a user's network traffic data to the service provider server 180, and the user identifier 130 may be used by the service provider server 180 to associate the user 102 with a particular user account maintained by the service provider server 180.

The service provider server 180, in various embodiments, may be maintained by an online service provider, which may provide information sharing and/or payment processing for online information and financial transactions on behalf of the user 102. The service provider server 180 includes at least one processing application 182, which may be adapted to interact with the client device 120 over the network 160 to facilitate information and/or financial transactions. In one example, the service provider server 180 may be provided by PayPal, Inc. of San Jose, Calif., USA.

The service provider server 180, in one embodiment, may include an agent 172 (e.g., operator, administrator, etc.) for providing customer service and support to the user 102 based on a service request by the user 102. In various implementations, providing customer service and support to the user 102 includes providing express customer service and support and may be referred to as fast track customer service. The service provider server 180 includes at least one agent application 183, which may be adapted to allow the agent 172 to interact with the user 102 to facilitate customer service and support operations in reference to various types of network transactions including information sharing over the network 160 and/or facilitating financial transactions over the network 160.

In one implementation, the agent application 183 allows the agent 172 to interact with the user 102 via the client device 120 over the network 160, which may include audio and video communication via the network 160. In another implementation, the agent application 183 allows the agent 172 to utilize an agent communication device 192 to interact with the user 102 via a client communication device 192. The communication devices 132, 192 may include at least one of a mobile communication device, wireless cell phone, personal digital assistant (PDA), land-line phone, etc. In various implementations, it should be appreciated by those skilled in the art that the client and agent communication devices 132, 192 may be integrated as part of the client device 132 and service provider server 192, respectively, without departing from the scope of the present disclosure.

The service provider server 180, in one embodiment, may be configured to maintain a plurality of user accounts in an account database 184, each of which may include account information 186 associated with individual users, including the user 102. For example, account information 186 may include identification information and/or private financial information of the user 102, such as one or more account numbers, identifiers, passwords, phone numbers, credit card information, banking information, or other types of financial information, which may be used to facilitate online transactions between the user 102 of the client device 120 and the service provider server 180. It should be appreciated that the methods and systems described herein may be modified to accommodate users that may or may not be associated with at least one existing user account.

The service provider server 180, in various embodiments, may include one or more databases 190 (e.g., internal and/or external databases) for storing and tracking information related to transactions between particular users, such as the user 102, and the service provider server 180. For example, the databases190 may provide an historical survey of information and financial transactions between the user 102 and the service provider 180. As such, in one implementation, the processing application 182 may be configured to track, log, and store transaction information and provide this information to the processing application 182 of the agent 172 for analysis.

In various embodiments, as discussed herein, the client device 120 and the service provider server 180 may be associated with a particular link (e.g., a link, such as a URL (Uniform Resource Locator) to an IP (Internet Protocol) address). In this regard, the service provider server 180 may interface with the browser application 122 of the client device 120 over the network 160 via appropriate websites and/or webpages to facilitate information and financial transactions between the client device 120 and the service provider server 180.

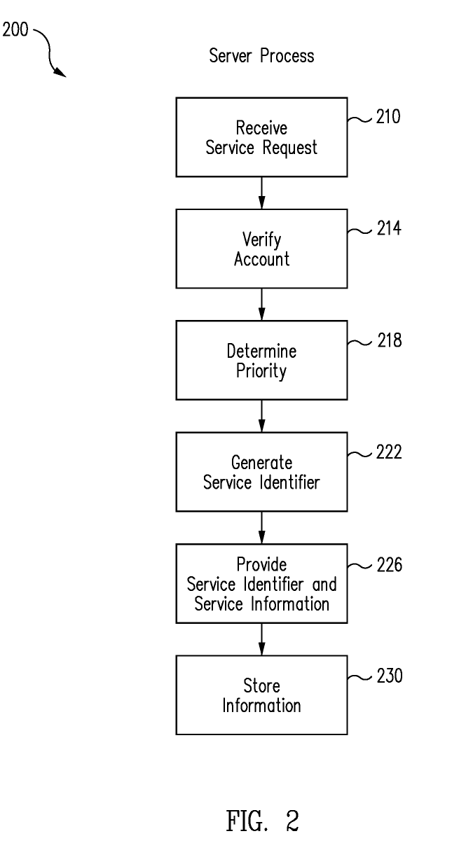

FIG. 2 shows one embodiment of a method 200 for facilitating customer service over the network 160. In one implementation, the method 200 comprises a server-side process that provides a user, such as the user 102, with service information to contact a customer service representative, such as the agent 172, associated with the service provider server 180 when a problem is encountered by the user 102.

Referring to FIG. 2, the method 200 involves the service provider server 180 receiving a service request from the user 102 (block 210) via a service site on the network 160, such as a website provided by the service provider server 180.

Next, the service provider server 180 verifies an account associated with the user 102 (block 214). In various implementations, verifying the account related to the user 102 may include accessing the account related to the use 102 for the account database 184. For example, the account may be accessed and verified based on information provided by the user 102 in the service request. Next, the service provider server 180 determines priority of service request (block 218).

In one example, the user 102 and the user's service request may be prioritized based on a perceived value and/or rating of the user 102, as determined by the service provider that maintains the service provider server 180. In various implementations, the user 102 is valued based on an amount of past value provided to the service provider (e.g., in terms of a number or value of transactions purchased or received in reference to the user 102), or based on prediction of a future value (e.g., the user 102 signs up via a specific channel that correlates to high profitability for the service provider).

In one embodiment, the value of the user 102 may be determined at the time the user 102 makes a service request. Alternately, in other embodiments, the value of the user 102 may be predetermined ahead of time and stored as part of the account information 186 in the account database 184. In one aspect, the value information related to the user 102 may or may not be accessed and/or displayed to the user 102 based on a value parameter associated with the user 102. In still other embodiments, the user 102 may be allowed to purchase a predetermined value to thereby access the fast track customer service each time a problem is encountered by the user 102.

In another example, the priority may be determined based on information provided by the user 102 in the service request. In various implementations, the user's email address, account identification number, and current URL that the user 102 is currently viewing may be passed with the service request so as to verify the user's account and determine priority of the user 102. As such, a highly valued user or top-rated user may receive preferential treatment (e.g., a higher priority) than other less-valued users. Next, the service provider server 180 generates a service identifier (block 222). In one implementation, the service identifier is generated based on the previously determined priority information. In another implementation, the service provider server 180 generates the service identifier based on routing the user 102 to a specific agent 172, which may be based on the priority and/or the type of problem encountered by the user 102 (e.g., a debit card related issue). As such, independent of the perceived priority, the service provider server 180 may choose to route the user 102 to a specific type of agent, which has the capability to resolve the specifically encountered problem and/or issue. Therefore, in various embodiments, the service provider server 180 may generate the service identifier based on the determined priority of the user 102 and/or the type of the problem encountered by the user 102, which may assist the service provider server 180 with routing the user's service request to an appropriate customer service agent 172 for an immediate response and resolution to the user's encountered problem.

In one embodiment, the service identifier may comprise a unique service code that provides the user 102 with access to assistance from the agent 172. For example, the unique service code may comprise a randomly generated alpha-numeric code having one or more digits. In one particular example, the unique service code may comprise a six-digit randomly generated number. It should be appreciated that the user 102 may have multiple accounts with the service provider server 180, but the user 102 may be prevented from obtaining multiple service identifiers within a single customer service event.

Next, the service provider server 180 provides the service identifier and service information to the user 102 (block 226). In various implementations, the service information includes a customer support telephone number to contact the agent 172 and a predetermined amount of time to contact the agent 172. For example, the predetermined amount of time may be five minutes. However, the predetermined amount of time may include any amount of time without departing from the scope of the present disclosure.

Next, the service request, the priority of the user, and/or the service identifier may be stored in a database component (e.g., database 190) of the service provider server 180 (block 230). In various implementations, the service request, the priority of the user, and/or the service identifier may be displayed on a display component of the service provider server 180 for viewing by a customer service agent, such as agent 172.

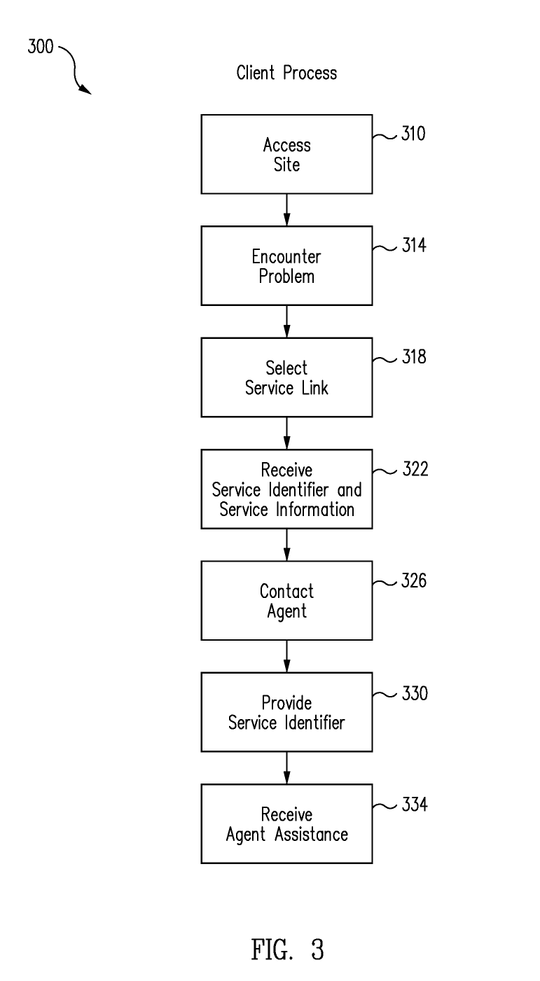

FIG. 3 shows one embodiment of a method 300 for facilitating customer service over the network 160. In one implementation, the method 300 comprises a client-side process that allows a user, such as the user 102, to request assistance from the service provider server 180 and contact a customer service representative, such as the agent 172, associated with the service provider server 180 when a problem is encountered by the user 102.

Referring to FIG. 3, the method 300 involves a user, such as the user 102, accessing (e.g., browsing) a service site on the network 160 (block 310), such as a website provided by the service provider server 180. In various examples, this may involve accessing a website having a plurality of linked pages made available over the network 160 by the service provider server 180.

Next, during network navigation of the service site, the user 102 may encounter a problem (block 314). For example, while trying to access an account and/or provide account information to the service provider server 180, the user 102 may encounter a problem with verifying identity and/or verifying banking information.

Next, after encountering a problem, the user 102 may select a service link to obtain customer service information from the service provider server 180 (block 318), if the user 102 is unable to resolve the problem. In various examples, this may involve the user 102 selecting an icon or GUI button on a webpage provided by the service provider server 180.

Next, upon selecting the service link, the user 102 receives a service identifier and additional service information (block 322) from the service provider server 180. In one implementation, the service identifier provides the user 102 with access to assistance from the agent 172. The user 102 may be redirected to another webpage that provides the unique service code. The user 102 may also receive additional service information, such as a customer support telephone number to contact the agent 172 and a predetermined amount of time to contact the agent 172. Next, the user 102 may contact the agent 172 (block 326), provide the service identifier to the agent 172 (block 330), and then receive assistance from the agent 172 (block 334). In various implementations, receiving assistance from the agent 172 includes receiving express customer service and support, which may be referred to as fast track customer service and support.

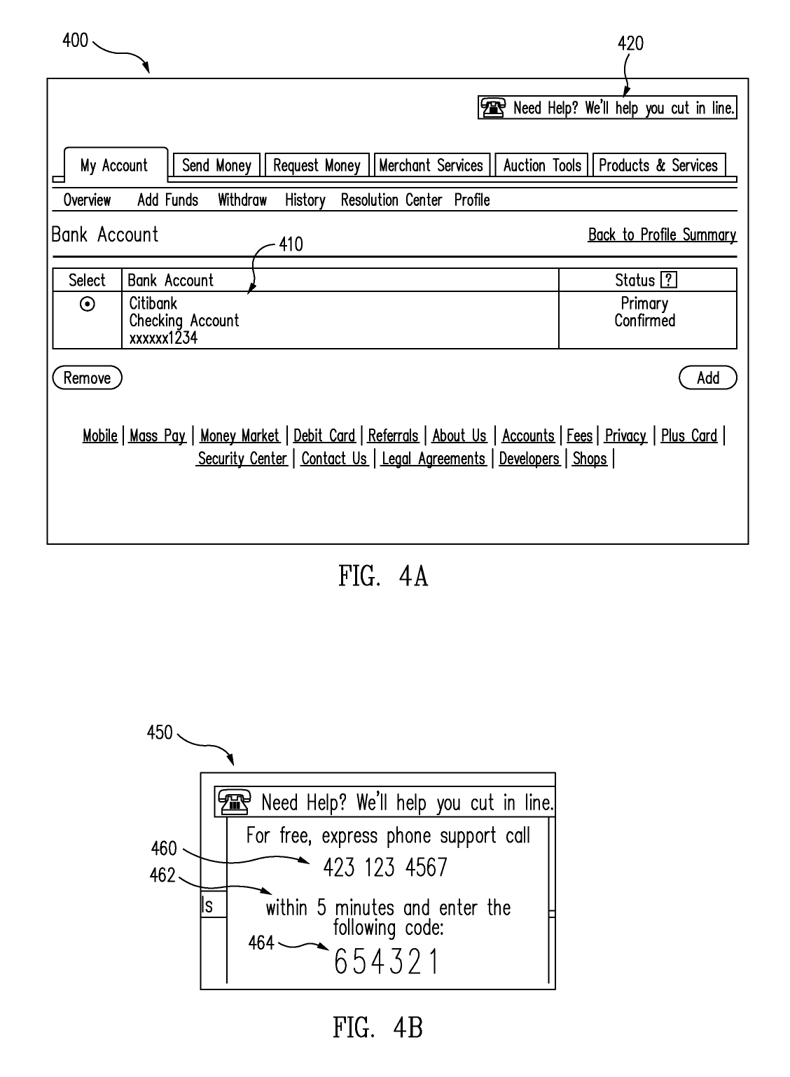

FIG. 4A shows one embodiment of a client interface application 400 that may be viewed by the user 102 during access of webpage provided by the service provider server 180 via the network 160. As shown in FIG. 4A, the client interface application 400 may comprise a webpage that the user 102 may access while trying to select a bank account 410 from the service provider server 180. If the user 102 encounters a problem, then the user 102 may select a service link 420 (e.g., GUI button) to obtain information related to customer service including express customer service (i.e., fast track customer service). Upon selecting the service link 420, the user 102 is provided with information related to customer service.

FIG. 4B shows one embodiment of a customer service information window 450 (e.g., express phone support) that may be provided and viewed by the user 102 after selecting the service link 420 of FIG. 4A. In one implementation, as shown in FIG. 4B, the customer service information window 450 may provide the user 102 with an express telephone support number 460 to contact the agent 172 for fast track customer service, a predetermined amount of time 462 to contact the agent, and/or a service identifier 464 (e.g., a unique service code) to receive express customer assistance from the agent 172.

In various implementations, the customer service information allows the user 102 to receive immediate attention and/or express support based on predetermined parameters, such as a user rating, wherein highly valued users and/or top-rated users are given priority over other users. The service identifier, when provided to a service provider, grants the user immediate access to a customer service agent. In various implementations, service identifier allows the user 102 to access express customer service and support, which may be referred to as fast track customer service and support.

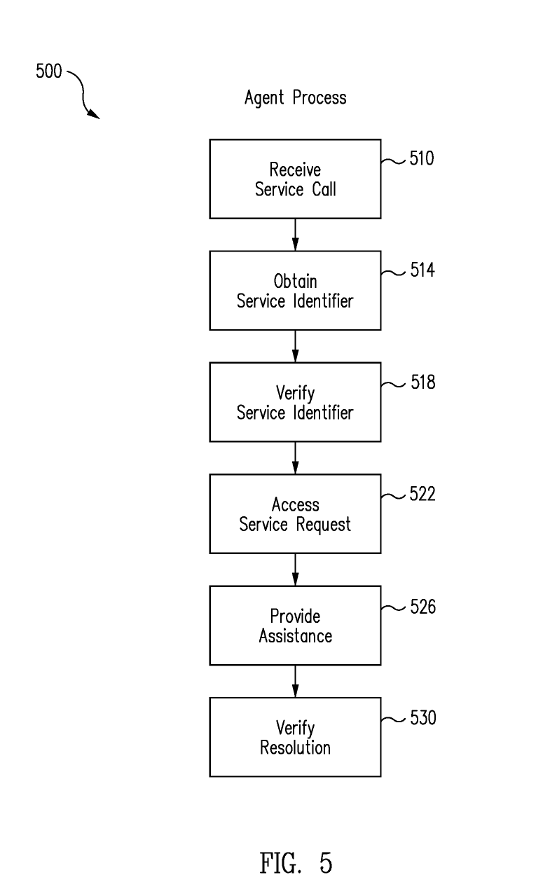

FIG. 5 shows one embodiment of a method 500 for facilitating customer service over the network 160. In one implementation, the method 500 comprises an agent-side process that allows a customer service representative, such as the agent 172, to be in contact with a user, such as the user 102, when a service request is received.

Referring to FIG. 5, the method 500 involves a customer service representative, such as the agent 172, receiving a service call from the user 102 (block 510) via a service site on the network 160, such as a website provided by the service provider server 180. In one aspect, the service call implies that the user 102 has encountered a problem while accessing the service provider server 180 over the network 160.

Next, the agent 172 obtains the service identifier from the user 102 (block 514). In one example, the agent 172 may obtain the service identifier from the user 102 by user input from a keypad on the client communication device 132, such as a cell phone. In another example, the agent 172 may obtain the service identifier from the user 102 with the user 102 speaking (e.g., speech communication) into the client communication device 132.

Next, the agent 172 verifies the service identifier (block 518) by accessing the service request (block 526) related to the service identifier as provided by the user 102. The agent 172 may access information related to the user 102, such as an account related to the user 102 stored in the account database 184 of the service provider server 180. In various examples, the agent 172 is adapted to interface with the service provider server 180 to access the service request related to the service identifier provided by the user 102. This allows the agent 172 to review and analyze data and information related to the problem encountered by the user 102 so as to determine and/or identify a resolution to the encountered problem.

Next, the agent 172 provides assistance to the user 102 (block 526). In one example, after review and analysis of the problem, the agent 172 provides assistance to the user 102 based on information provided by the user 102 and stored as part of service request.

Next, the agent 172 verifies that a resolution to the problem encountered by the user 102 was achieved (block 530). In various implementations, the problem resolution and/or overall user experience may be stored or archived in a database (e.g., database 190) of the service provider server 180.

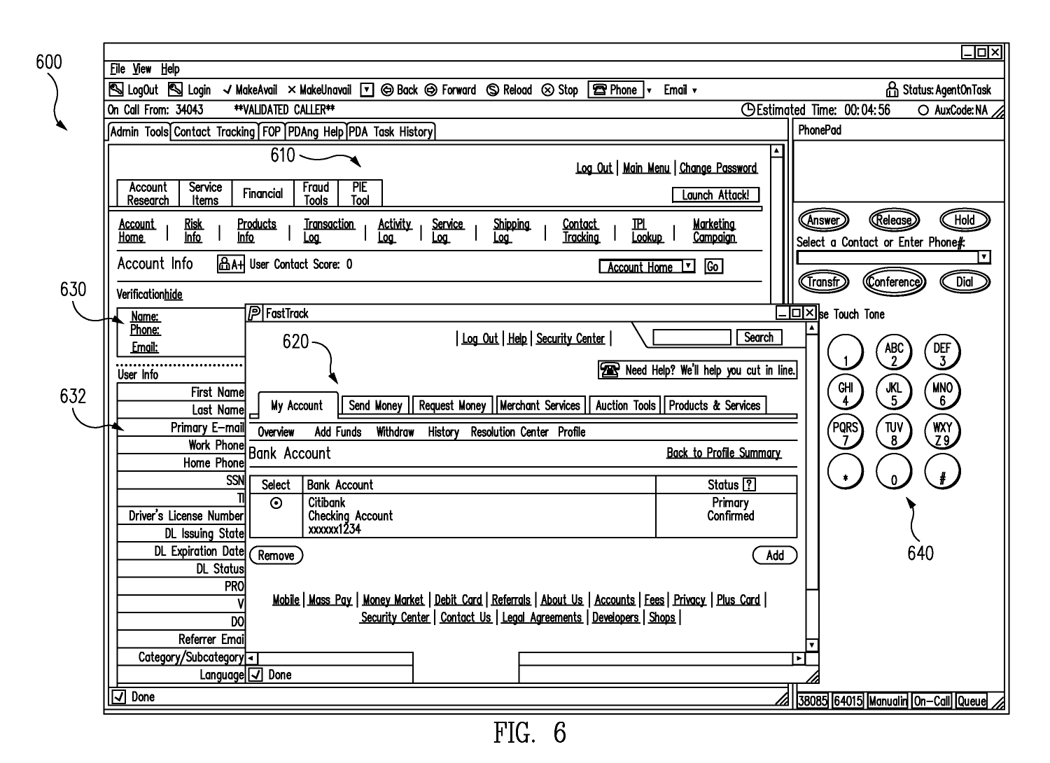

FIG. 6 shows one embodiment of an agent interface application 600 that may be viewed by the agent 172 during access of a customer service webpage provided by the service provider server 180. As shown in FIG. 6, the agent interface application 600 may comprise an agent service webpage 610 that the agent 172 may access while trying to assist the user 102 with correcting a problem encountered by the user 102. The agent 172 may view an archived copy 620 of the webpage 400 of FIG. 4A that the user 102 viewed after selecting the service link 420. The agent 172 may also view and verify the service identifier (e.g., a unique service code) provided to the user 102, wherein the service identifier may be used to access archived information related to the problem encountered by the user 102.

In various implementations, referring to FIG. 6, the agent service webpage 610 may be adapted to provide the agent 172 with information related to the user 102, such as user verification information 630 and user identification information 632. The agent service webpage 610 may be adapted to include a telephone interface 640 that allows the agent 172 to contact the user 102.

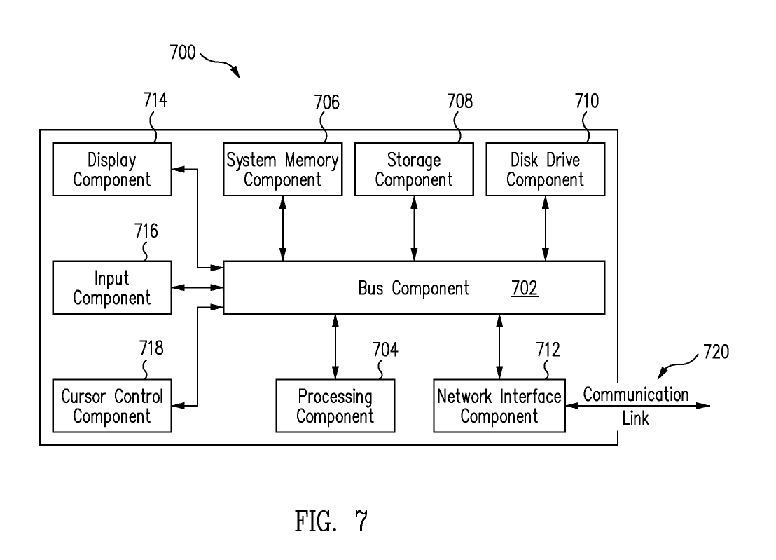

FIG. 7 is a block diagram of a computer system 700 suitable for implementing embodiments of the present disclosure, including the client device 120, the one or more resource provider devices 140, and the service provider device 180. In various implementations, the client device 140 may comprise a personal computing device, such as a personal computer, laptop, PDA, etc., the one or more resource provider devices 140 may comprise a network computing device, such as a server, and the service provider server 180 may comprise a network computing device, such as a server. Thus, it should be appreciated that the devices 120, 140, 180 may be implemented as the computer system 700 in a manner as described herein.

In accordance with various embodiments of the present disclosure, computer system 700, such as a personal computer and/or a network server, includes a bus 702 or other communication mechanism for communicating information, which interconnects subsystems and components, such as processing component 704 (e.g., processor, micro-controller, digital signal processor (DSP), etc.), system memory component 706 (e.g., RAM), static storage component 708 (e.g., ROM), disk drive component 710 (e.g., magnetic or optical), network interface component 712 (e.g., modem or Ethernet card), display component 714 (e.g., CRT or LCD), input component 716 (e.g., keyboard), and cursor control component 718 (e.g., mouse or trackball). In one implementation, disk drive component 710 may comprise a database having one or more disk drive components.

In accordance with embodiments of the present disclosure, computer system 700 performs specific operations by processor 704 executing one or more sequences of one or more instructions contained in system memory component 706. Such instructions may be read into system memory component 706 from another computer readable medium, such as static storage component 708 or disk drive component 710. In other embodiments, hard-wired circuitry may be used in place of or in combination with software instructions to implement the present disclosure.

Logic may be encoded in a computer readable medium, which may refer to any medium that participates in providing instructions to processor 704 for execution. Such a medium may take many forms, including but not limited to, non-volatile media, volatile media, and transmission media. In various implementations, non-volatile media includes optical or magnetic disks, such as disk drive component 710, volatile media includes dynamic memory, such as system memory component 706, and transmission media includes coaxial cables, copper wire, and fiber optics, including wires that comprise bus 702. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 700. In various other embodiments of the present disclosure, a plurality of computer systems 700 coupled by communication link 720 (e.g., network 160 of FIG. 1, LAN, WLAN, PTSN, or various other wired or wireless networks) may perform instruction sequences to practice the present disclosure in coordination with one another.

Computer system 700 may transmit and receive messages, data, information and instructions, including one or more programs (i.e., application code) through communication link 720 and communication interface 712. Received program code may be executed by processor 704 as received and/or stored in disk drive component 710 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure.

Having thus described embodiments of the present disclosure, persons of ordinary skill in the art will recognize that changes may be made in form and detail without departing from the scope of the present disclosure. Thus, the present disclosure is limited only by the claims.

1. A system for facilitating customer service over a network, the system comprising:
a network interface component adapted to communicate with a user via a client device over the network; and
a processing component adapted to receive a service request from the user via the network, verify an account related to the user, determine a priority for the user, generate a service identifier, and provide the service identifier and service information to the user via the network,
wherein the service information includes a customer support telephone number and a predetermined amount of time to contact a customer service agent via the customer support telephone number.

2. The system of claim 1, wherein the service request includes information related to a problem encountered by the user.

3. The system of claim 1, wherein the service request includes at least one of an email address, an account identification number, and a uniform resource locator (URL) related to the user.

4. The system of claim 1, wherein the processing component verifies the account related to the user based on information passed with the service request.

5. The system of claim 1, wherein the processing component determines the priority of the user by prioritizing the user based on a perceived value of the user.

6. The system of claim 1, wherein the processing component generates the service identifier based on at least one of the determined priority of the user and a type of problem encountered by the user.

7. The system of claim 1, wherein the processing component generates the service identifier by generating a unique service code including a randomly generated alpha-numeric code having one or more digits.

8. The system of claim 1, wherein the processing component is adapted to access the account related to the user.

9. The system of claim 1, wherein the processing component is adapted to store at least one of the service request, the priority of the user, and the service identifier.

10. The system of claim 1, wherein the processing component is adapted to display at least one of the service request, the priority of the user, and the service identifier.

11. The system of claim 1, wherein the client device comprises a computer adapted to communicate with at least one of the network interface component and the processing components via the network.

12. The system of claim 1, wherein the client device includes a browser application adapted to allow the user to interface with at least one of the network interface component and the processing components via the network.

13. The system of claim 1, wherein the system comprises a server adapted to facilitate customer service over the network.

14. A method for facilitating customer service over a network, the method comprising:
receiving a service request from a user over the network via a network communication component;
verifying an account related to the user;
determining a priority of the user;
generating a service identifier;
storing the service identifier in a memory component; and
providing the service identifier and service information to the user over the network via the network communication component,
wherein the service information includes a customer support telephone number and a predetermined amount of time to contact a customer service agent via the customer support telephone number.

15. The method of claim 14, wherein the service request includes information related to a problem encountered by the user.

16. The method of claim 14, wherein the service request includes at least one of an email address, an account identification number, and a uniform resource locator (URL) related to the user.

17. The method of claim 14, wherein verifying the account related to the user is based on information passed with the service request.

18. The method of claim 14, wherein determining the priority of the user comprises prioritizing the user based on a perceived value of the user.

19. The method of claim 14, wherein generating the service identifier is based on the determined priority of the user.

20. The method of claim 14, wherein generating the service identifier comprises generating a unique service code including a randomly generated alpha-numeric code having one or more digits.

21. The method of claim 14, further comprising accessing the account related to the user.

22. The method of claim 14, further comprising storing at least one of the service request and the priority of the user in the memory component.

23. The method of claim 14, further comprising displaying at least one of the service request, the priority of the user, and the service identifier.

24. The method of claim 14, further comprising communicating with the user via a client device over the network.

25. The method of claim 14, wherein the method is performed by a server adapted to facilitate customer service over the network.

26. Software encoded in one or more computer readable media and when executed operable to:
communicate with a user via a client device over a network via a network communication component;
receive a service request from the user via the network;
verify an account related to the user;
determine a priority of the user;
generate a service identifier;
store the service identifier in a memory component; and
provide the service identifier and service information to the user over the network via a network communication component,
wherein the service information includes a customer support telephone number and a predetermined amount of time to contact a customer service agent via the customer support telephone number.
